(19) United States
(12) Patent Application Publication
(10) Pub. No.: US 2026/0021498 A1
(43) Pub. Date: Jan. 22, 2026

(54) Process for Spraying a Band of Foam and Dispensing Nozzle Therefore

(71) Applicant: DDP SPECIALTY ELECTRONIC MATERIALS US, LLC, WILMINGTON, DE (US)

(72) Inventors: DANIEL SCHROER, MIDLAND, MI (US); JOSEPH LANGMAID, MIDLAND, MI (US); KYOUNG MOO KOH, MIDLAND, MI (US)

(21) Appl. No.: 19/264,381

(22) Filed: Jul. 9, 2025

Related U.S. Application Data
(60) Provisional application No. 63/671,927, filed on Jul. 16, 2024.

(51) Int. Cl. B05B 1/04

(52) U.S. Cl. CPC B05B 1/042

(57) ABSTRACT

A process for spraying a band of foam of desired width on a surface, comprising a) providing a pressurized source of foamable material b) dispensing onto a surface a fan spray of the foamable material from a dispensing nozzle, and c) moving the dispensing nozzle perpendicular to the centerline plane of the fan spray to form the band of foam; wherein the dispensing nozzle comprises an exit orifice connected to a fan spray tip, the fan spray tip having a transverse slot in the exit face of the dispensing nozzle formed from spray-limiting walls, the transverse slot having a curved vertex end having vertex and an exit face end, and wherein the exit orifice has a dimension L parallel to the transverse slot; the facing surfaces of the spray-limiting walls are set apart a dimension of W, with W less than or equal to dimension L; the transverse slot having an overall depth D measured from the exit face to the vertex of the transverse slot, and the ratio of D:W is 0.30 to 2.40.

### BACKGROUND OF THE INVENTION

Field of the Invention. This invention relates to spray tips that allow for more precise application of a fan of material such as foam, to form a band of foam having a desired width on a surface with limited overspray.

Description of Related Art. Dispensers of foam have historically utilized a V-shaped spray tip geometry to generate a fan spray pattern. By V-shaped, it is meant these spray tip nozzles have a V-shape cut, oriented orthogonally to the direction of the spray direction, which can create a “cat's eye” opening in the inner diameter flow channel of the spray nozzle when looking normal to the exit face of the spray nozzle. The V-shape distributes the foam in a planar manner when exiting the spray tip. However, while the V-shaped notch tip can create a wide spray pattern, forming bands of foam material that can cover a large area, the V-shaped spray tip geometry can create excessive and undesirable overspray that contaminates areas where the spray is unwanted.

Therefore, what is needed is a process for spraying a band of foam of a desired width on a surface, utilizing a dispensing nozzle that suppresses the amount of overspray outside that desired width of the band.

### BRIEF SUMMARY OF THE INVENTION

This invention relates to a process for spraying a band of foam of a desired width on a surface, comprising:

a) providing a pressurized source of foamable material having a dispensing nozzle for spraying a fan spray, or attaching a dispensing nozzle for spraying a fan spray to a pressurized source of foamable material,

wherein said pressurized source is in fluid connection with the dispensing nozzle,

the dispensing nozzle comprising an exit orifice for discharging the pressurized material, the exit orifice in fluid connection with a fan spray tip for forming the fan spray, the fan spray tip forming an exit face of the dispensing nozzle,

wherein the fan spray tip provides a transverse slot in the exit face of the dispensing nozzle, the transverse slot formed by first and second spray-limiting walls, the walls having facing surfaces set apart from each other at the exit face of the dispensing nozzle, the transverse slot having a curved vertex end and an exit face end, wherein the curved vertex end is in fluid connection with the exit orifice, and the exit face end is in fluid connection with the exit face of the dispensing nozzle,

wherein the first spray-limiting wall has an interior surface facing the second spray-limiting wall, and the second spray-limiting wall has an interior surface facing the first spray-limiting wall, and

wherein between the exit face end and the curved vertex end of the transverse slot, the interior surface of the first spray-limiting wall has curvature towards the interior surface of the second spray-limiting wall, and the interior surface of the second spray-limiting wall has curvature towards the interior surface of the first spray-limiting wall, the two interior surfaces joining to form the curved vertex end of the traverse slot at the exit orifice, the curved vertex end having a vertex, and wherein
i) the exit orifice has a dimension L parallel to the transverse slot at the connection to the fan spray tip,
ii) the facing surfaces of the first and second spray-limiting walls are set apart a dimension W at the exit face of the dispensing nozzle,
iii) the transverse slot has an overall depth D from the exit face of the dispensing nozzle to the vertex of the transverse slot, and
iv) the ratio of D:W is 0.30 to 2.40;

b) dispensing onto a surface a fan spray of the foamable material from the dispensing nozzle, the fan spray having a centerline plane that is parallel with the slot in the dispensing nozzle, and

c) moving the dispensing nozzle perpendicular to the centerline plane of the fan spray to form a band of foam of the desired width on the surface.

This invention also relates to a dispensing nozzle for spraying a fan spray of a foamable material, the dispensing nozzle comprising an exit orifice and a fan spray tip, the exit orifice for discharging the foamable material and the fan spray tip for forming the fan spray, the fan spray tip forming an exit face of the dispensing nozzle,

wherein the fan spray tip provides a transverse slot in the exit face of the dispensing nozzle, the transverse slot formed by first and second spray-limiting walls, the walls having facing surfaces set apart from each other at the exit face of the dispensing nozzle, the transverse slot having a curved vertex end and an exit face end, wherein the curved vertex end is in fluid connection with the exit orifice, and the exit face end is in fluid connection with the exit face of the dispensing nozzle,

wherein the first spray-limiting wall has an interior surface facing the second spray-limiting wall, and the second spray-limiting wall has an interior surface facing the first spray-limiting wall, and

wherein between the exit face end and the curved vertex end of the transverse slot, the interior surface of the first spray-limiting wall has curvature towards the interior surface of the second spray-limiting wall, and the interior surface of the second spray-limiting wall has curvature towards the interior surface of the first spray-limiting wall, the two interior surfaces joining to form the curved vertex end to the traverse slot at the exit orifice, the curved vertex end having a vertex, and wherein
i) the exit orifice has a dimension L parallel to the transverse slot at the connection to the fan spray tip,
ii) the facing surfaces of the first and second spray-limiting walls are set apart a dimension of W at the exit face of the dispensing nozzle,
iii) the transverse slot has an overall depth D from the exit face of the dispensing nozzle to the vertex of the transverse slot, and
iv) the ratio of D:W is 0.30 to 2.40.

### BRIEF DESCRIPTION OF THE DRAWINGS

FIG. 1 is an idealized illustration of the act of spraying a band of foam of a desired width on a surface, and possible features of that band of foam.

FIG. 2 is a digital photo of a V-shaped fan spray tip of the prior art, as viewed from the side.

FIG. 3 is digital photo of a fan spray tip having a transverse slot that has a curved interior surface that does not end at a point, as viewed from the side.

FIGS. 4 & 6 are illustrations of a V-shaped fan spray tip of the prior art, as viewed from the end, looking normal to the exit face of the spray nozzle. FIG. 4 illustrates no taper to the transverse slot form the hollow annular channel 21 of the dispensing nozzle, while FIG. 6 illustrates a possible taper from the hollow annular channel 21 to the transverse slot.

FIGS. 5 & 7 are illustrations of a fan spray tip having a transverse slot that has a curved interior surface that does not end at a point, as viewed from the end, looking normal to the exit face of the spray nozzle. FIG. 5 illustrates no taper to the transverse slot form the hollow annular channel 21 of the dispensing nozzle, while FIG. 7 illustrates a second taper, as described herein, from the hollow annular channel 21 to the transverse slot.

FIG. 8 is an isometric view of a dispensing nozzle comprising a hollow annular channel and a fan spray tip, the fan spray tip forming the exit face of the dispensing nozzle, and the fan spray tip further having a transverse slot in the exit face.

FIG. 9 provides a cross sectional view of the dispensing nozzle shown in FIG. 8 shown cut through the lengthwise center of the dispensing nozzle, splitting the two spray limiting walls.

FIGS. 10 & 11 illustrate the first and second spray-limiting walls of the fan spray tip, with the walls having facing internal or interior surfaces. The figures also illustrate a dimension “W” between the facing wall surfaces, measured at the exit face of the dispensing nozzle; and the overall depth “D” measured from the exit face of the dispensing nozzle to the vertex of the transverse slot.

FIG. 12 is a is an isometric view of the dispensing nozzle shown in FIG. 8 shown cut lengthwise through the centerline axis of the hollow annular cylinder, the cut showing a cross sectional orthogonal to the view shown in FIG. 9.

FIGS. 13a & 13b are possible variants of the hollow annular channel in the form of a tapered cylinder, the dispensing nozzle shown cut lengthwise through the centerline axis of the hollow annular cylinder as in FIG. 12 or 14.

FIG. 14 is an isometric view illustrating the dispensing nozzle of FIG. 13b, which has the second taper in the fan spray tip.

FIG. 15 is a digital photo of a foam band having excessive overspray made using a V-shaped fan spray tip of the prior art.

FIG. 16 is a digital photo of a foam band having reduced overspray made using the inventive spray fan tip having a transverse slot that has a curved interior surface that does not end at a point.

### DETAILED DESCRIPTION OF THE INVENTION

This invention relates to a process for spraying a band of foam of desired width on a surface, comprising a) providing a pressurized source of foamable material having a dispensing nozzle for spraying a fan spray, or attaching a dispensing nozzle for spraying a fan spray to a pressurized source of foamable material, b) dispensing onto a surface a fan spray of the foamable material from the dispensing nozzle, and c) moving the dispensing nozzle perpendicular to the centerline plane of the fan spray to form the band of foam. It has been found that using a dispensing nozzle having a fan spray tip of the particular geometry disclosed herein, specifically a spray fan tip having a transverse slot that has a curved interior surface that does not end at a point, allows the placement of a more uniform band of foam on a surface.

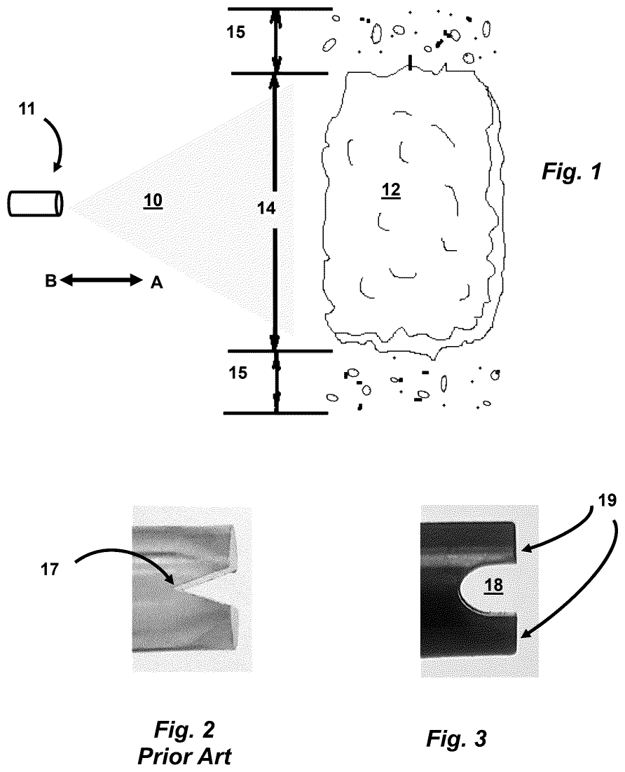

FIG. 1 is an idealized illustration of spraying a band of foam of a desired width on a surface, and possible features of that band of foam. Shown is an idealized a triangular-shaped fan spray 10 of foam being sprayed from a dispensing nozzle spray tip 11, and the band of foam 12 that is formed on a surface by moving the dispensing nozzle spray tip linearly from about position A to B. As shown, there is a desired width (dimension 14) of the sprayed band of foam. However, with tips of the prior art, an excessive amount of undesirable additional bands of foam overspray, shown with width 15, occur on either side of the desired sprayed band of foam 12.

Excessive overspray of this nature occurs with the use of a V-shaped fan spray tip of the prior art as shown in FIG. 2 that ends at a point 17; However, it has been found that the use of a dispensing nozzle having a fan spray tip that has an curved interior surface that does not end at a point, such as shown in FIG. 3, provides a sprayed band of foam with minimal overspray; that is, it has smaller overspray bands on either side of the desired band of foam. The inventive fan spray tip of FIG. 3 is shown having a transverse slot 18 having a curved interior surface that does not end at a point. The transverse slot bisects the exit face of the fan spray tip, formed by two spray-limiting walls, with the exit face of the fan spray tip comprising the outer faces 19 of those two spray-limiting walls. The phrase “the exit face of the fan spray tip” and “the exit face of the dispensing nozzle” are used interchangeably herein.

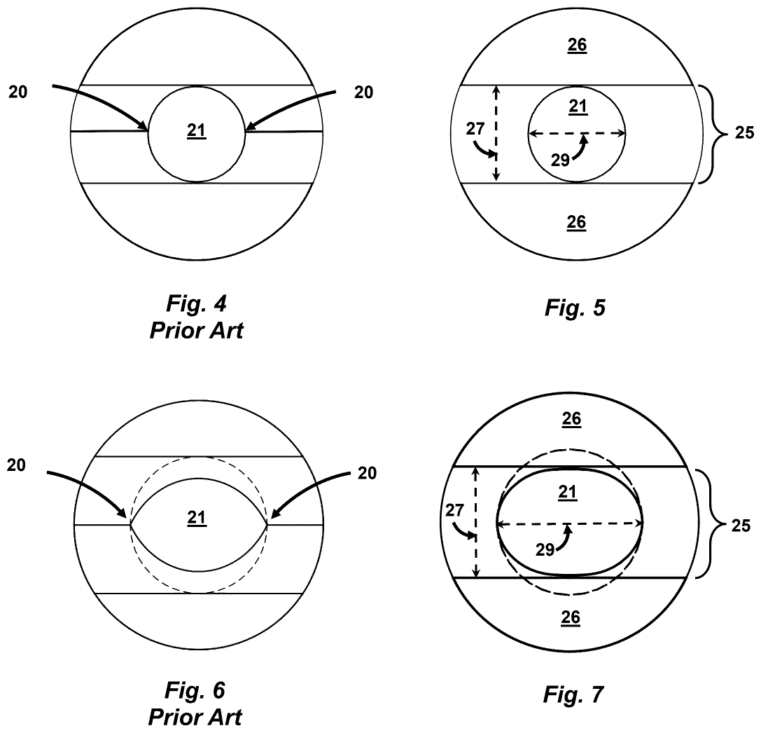

A transverse slot that has a curved interior surface that does not end at a point is further illustrated as follows. FIGS. 4 & 6 are illustrations of possible V-shaped fan spray tips of the prior art. This is a view of the exit face of the prior art fan spray tip as viewed from the end, looking normal to the exit face of the spray nozzle; in other words, as viewed orthogonal to the side view shown in FIG. 2. FIG. 4 illustrates no taper from the hollow annular channel of the dispensing nozzle, while FIG. 6 illustrates either a narrow V-cut or a possible taper from the hollow annular channel. The wider diameter of the hollow annular channel is shown by the dotted line. Regardless of the depth of the V-cut, the use of a V-shaped slot in the fan spray tip creates a sharp point 20 on either side of, and adjacent to, the hollow center flow channel 21 of the spray tip.

FIGS. 5 & 7 are illustrations of an inventive fan spray tip having a transverse slot 25 that bisects the exit face of the fan spray tip, forming two spray-limiting walls that comprise the exit face 26 of the fan spray tip (and the dispensing nozzle). This is a view of the exit face of the inventive fan spray tip as viewed from the end, looking normal to the exit face of the spray nozzle; in other words, orthogonal to the side view shown in FIG. 3. The transverse slot has a curved interior surface that does not end at a point, as shown in FIG. 3. FIG. 5 illustrates no taper to the transverse slot form the hollow annular channel 21 of the dispensing nozzle, while FIG. 7 illustrates a taper from the hollow annular channel to the transverse slot. The wider diameter of the hollow annular channel is shown by the dotted line, which tapers to the fan spray tip. The use of a slot having a curved interior surface does not create a sharp point on either side of, and adjacent to, the hollow annular channel 21 of the spray tip.

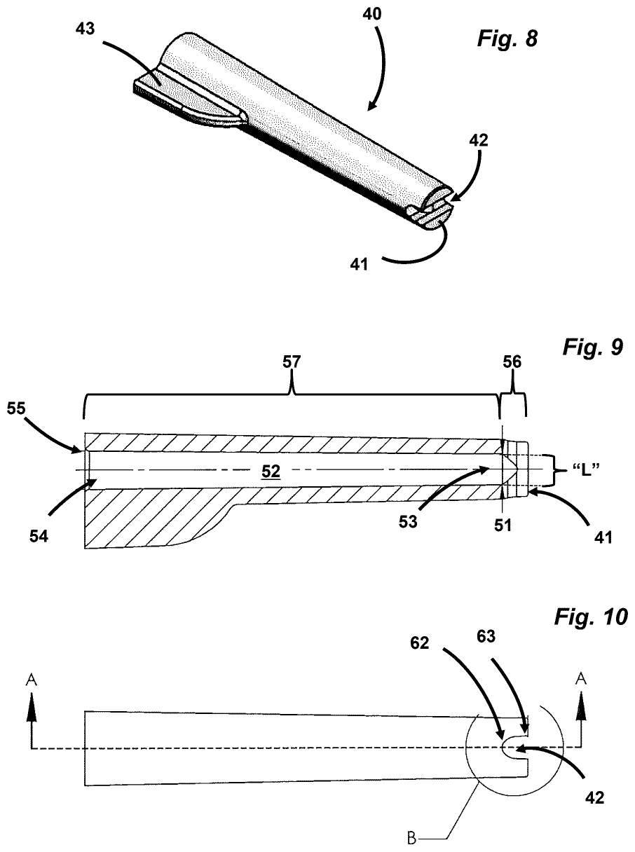

Features and one embodiment of a dispensing nozzle are shown in FIGS. 8 to 11. FIG. 8 is an isometric view of the dispensing nozzle 40 having the fan spray tip forming the exit face 41 of the dispensing nozzle. The fan spray tip has a transverse slot 42 in the exit face of the dispensing nozzle; the transverse slot bisecting the exit face of the fan spray tip and being formed or bounded by first and second spray-limiting walls, the walls having interior facing surfaces set apart from each other at the exit face of the dispensing nozzle. This dispensing nozzle is shown with an optional dispensing fin 43 that is aligned with and parallel to the spray-limiting walls, to indicate the directionality of the transverse slot and the orientation of the fan spray made by the fan spray tip.

At a minimum, the dispensing nozzle comprises an exit orifice and a fan spray tip. The exit orifice is for discharging the pressurized material to the fan spray tip, and the fan spray tip forms the fan spray. In some embodiments, however, the dispensing nozzle further comprises a dispensing body having a hollow annular channel. FIG. 9 provides a cross sectional view of the dispensing nozzle shown in FIG. 8 shown cut through the lengthwise center of the dispensing nozzle, splitting the two spray limiting walls (essentially view A-A from FIG. 10). In FIG. 9, the fan spray tip part of the dispensing nozzle is designated by section 56 and the hollow annular channel part of the dispensing nozzle is designated by section 57. The fan spray tip extends from the exit face of the fan tip 41 (and the dispensing nozzle) to a transverse plane 51 orthogonal to a centerline of the dispensing nozzle, at the vertex 79 of the vertex end 62 of the transverse slot as shown in FIGS. 10 & 11. By use of the term “vertex” it is meant the common definition used in the geometry of plane curves, meaning this is the local maximum point of curvature, particularly in this instance the maximum point of curvature of the joined interior surfaces of the two spray limiting walls at the curved vertex end of the traverse slot, which is typically the meeting point of those two interior curved surfaces at the curved vertex end of the traverse slot. The vertex is preferably a point on the transverse plane 51 on the centerline axis of the dispersing nozzle, particularly if the two spray limiting walls are symmetrically sized and positioned (mirror images thereof), as is shown and preferred in many embodiments.

The transverse plane 51 can be considered the dividing line between the hollow annular channel and the fan spray tip. The diameter of the exit orifice is also defined herein as the dimension “L” of the orifice in that transverse plane 51. Therefore, the fan spray tip part of the dispensing nozzle 56 is the section only at the extreme end of this particular embodiment of this dispensing nozzle. The diameter of the exit orifice defined herein as the dimension “L” of the orifice in the transverse plane 51. Dimension “L” of the orifice in the transverse plane is further illustrated as the diameter or dimension 26 of FIGS. 5 & 7.

This embodiment of FIG. 9 further comprises a hollow annular channel 52 through the dispensing nozzle for the passage of the pressurized material through the dispensing nozzle, this part of the dispensing nozzle further designated by section 57. The hollow annular channel has a hollow annular channel exit end 53 at the exit orifice and an opposing hollow annular channel entrance end 54 at the opposing or entrance face of the nozzle. The hollow annular channel entrance end 54 of the dispensing nozzle can be further provided with a bevel 55 to fit a desired pressurized source of material or hose or straw connection.

The hollow annular channel entrance end 54 is for fluid connection to a pressurized source of foamable material; while the exit end 53 is in fluid communication with the exit orifice. In some preferred embodiments, the pressurized source can be an aerosol can or propellant container.

FIG. 10 further illustrates the transverse slot 42 from FIG. 8. The transverse slot has a curved vertex end 62 and an exit face end 63, wherein the curved vertex end is in fluid connection with the exit orifice, and the exit face end is in fluid connection with the exit face of the dispensing nozzle, forming a flow channel, preferably having a straight-line axis, through the dispensing nozzle from the hollow annular channel entrance end 54 of the dispensing nozzle through the exit orifice and transverse slot to and through the exit face of the dispensing nozzle. As shown in FIGS. 10 & 11, between the exit face end and the curved vertex end of the transverse slot the interior facing surfaces of the spray-limiting walls have curvature towards one another, the curved facing surfaces joining to form the curved vertex end to the traverse slot at the exit orifice. This detail B from FIG. 10 is further shown in FIG. 11. First and second spray-limiting walls 75, 76, are shown, with the walls having interior facing surfaces 77,78 respectively that curve towards each other, the surfaces meeting at the vertex 79 of the transverse slot. FIG. 11 also illustrates the dimension “W” between the interior facing wall surfaces (measured at the exit face), and the overall depth “D” as the distance measured from the exit face of the dispensing nozzle to the vertex 79 of the transverse slot.

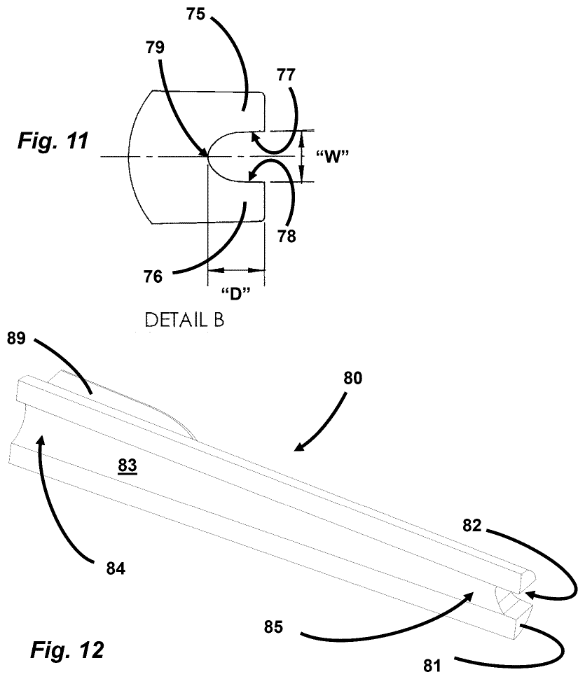

FIGS. 12, 13a, 3b, and 14 illustrate various features and embodiments of a dispensing nozzle comprising a fan spray tip. FIG. 12 is a is an isometric view of the dispensing nozzle shown in FIG. 8 shown cut lengthwise through the centerline axis of the hollow annular cylinder, (which is the dotted line of A-A in FIG. 10; a line that is also considered the centerline axis of the dispensing nozzle), the cut showing a cross sectional orthogonal to the view shown in FIG. 9. FIG. 12, shows dispensing nozzle 80 having the fan spray tip forming the exit face 81 of the dispensing nozzle. The fan spray tip has the transverse slot 82 and the dispensing nozzle has the hollow annular channel 83 through the dispensing nozzle for the passage of the pressurized material through the dispensing nozzle. The hollow annular channel is in the form of a tapered hollow cylinder, with the hollow annular channel exit end 85 at the exit orifice having a smaller diameter than the diameter of the cylinder at the opposing hollow annular channel entrance end 84 at the opposing or entrance face of the nozzle. The exit face of this embodiment would have the appearance (normal to the exit face) of FIG. 5. Also shown is dispenser fin 89 aligned with the plane of the transverse slot to easily judge the directionality of the fan spray; in other words, the dispenser fin acts as a sighting fin, preferably indicating the directionality of plane of the fan of foam exiting from the dispensing nozzle.

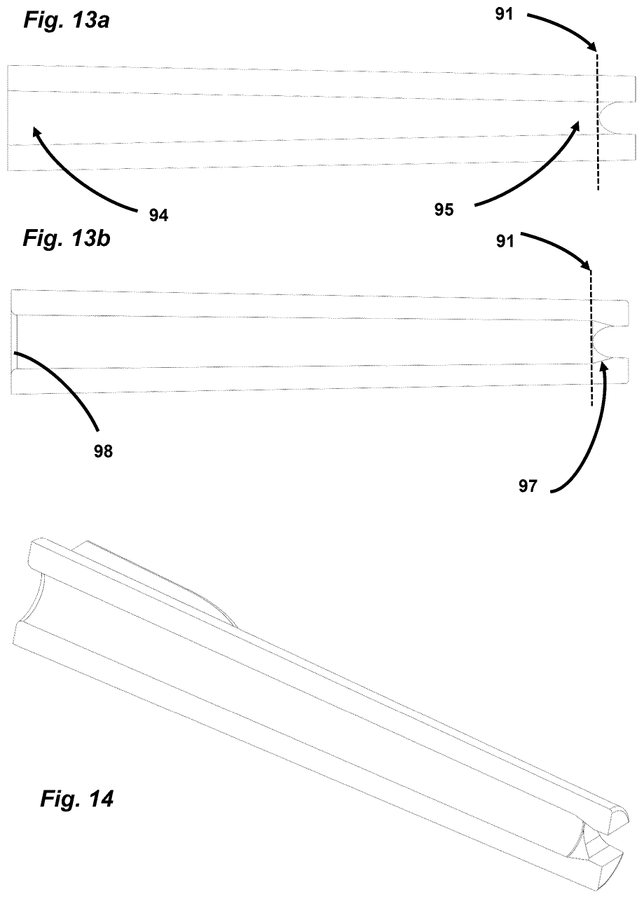

FIGS. 13a & 13b are a couple of possible variants of the hollow annular channel in the form of a tapered cylinder, the dispensing nozzle shown cut lengthwise through the centerline axis of the hollow annular cylinder. The tapered design of the hollow annular channel facilities the manufacture of the dispensing nozzle via injection molding. FIG. 13a shows the hollow annular channel having a single straight taper throughout, the taper extending from the hollow annular channel entrance end 94 to the hollow annular channel exit end 95, where the channel ends at the transverse plane 91 orthogonal to the centerline axis of the hollow annular channel of the dispensing nozzle; this transverse plane 91 is located at the beginning of the exit orifice, which is also the vertex of the vertex end of the transverse slot. As shown in this embodiment, the taper further extends into the fan spray tip, maintaining the same linear angle from the hollow annular channel until it naturally contacts the facing surfaces of the spray limiting walls.

FIG. 13b shows the hollow annular channel having the same straight taper as in FIG. 13a until the channel ends at the transverse plane 91 orthogonal to the centerline axis of the hollow annular channel of the dispensing nozzle. However, FIG. 13b further illustrates the spray fan tip can have a second different linear taper 97 that narrows the channel, starting at the transverse plane and extending into the spray fan tip until it contacts the facing surfaces of the spray limiting walls. This additional second taper is shown having a wider or sharper angle (with reference to the centerline axis of the hollow annular channel) than the taper of the hollow annular channel. The exit face of this embodiment would have the appearance (normal to the exit face) of FIG. 7. FIG. 13b also illustrates the hollow annular channel entrance end of the dispensing nozzle can be further provided with a bevel 98 to fit a desired pressurized source of material or hose or straw connection. FIG. 14 is an isometric view of a dispensing nozzle similar to FIG. 12, but illustrating the dispensing nozzle of FIG. 13b, which has the second taper in the fan spray tip.

The use of a different linear taper, starting at the transverse plane 91 and extending into the spray fan tip until it contacts the facing surfaces of the spray limiting walls, can result in the orifice exit dimension “L” differing from the dimension “W” between the facing surfaces of the spray limiting walls at the exit face, as shown by the “W” dimension 27 and “L” dimension 29 in the embodiment of FIG. 7. Preferably, the “W” dimension between the facing surfaces of the spray limiting walls 27 is equal to or less than the orifice exit dimension “L”, as shown by 29 in FIGS. 5 & 7.

The process for spraying a band of foam of a desired width on a surface comprises:

a) providing a pressurized source of foamable material having a dispensing nozzle for spraying a fan spray, or attaching a dispensing nozzle for spraying a fan spray to a pressurized source of foamable material, wherein said pressurized source is in fluid connection with a dispensing nozzle, the dispensing nozzle comprising an exit orifice for discharging the pressurized material, the exit orifice connected to and in fluid connection with a fan spray tip for forming the fan spray,

b) dispensing onto a surface a fan spray of the foamable material from the dispensing nozzle, the fan spray having a centerline plane that is parallel with the slot in the dispensing nozzle, and

c) moving the dispensing nozzle perpendicular to the centerline plane of the fan spray to form a band of foam of the desired width on the surface.

This process preferably uses a dispensing nozzle for spraying a fan spray of a foamable material, the dispensing nozzle comprising an exit orifice and a fan spray tip, the exit orifice for discharging the foamable material and the fan spray tip for forming the fan spray, the fan spray tip forming an exit face of the dispensing nozzle.

The fan spray tip forms both the exit face of the dispensing nozzle and provides a transverse slot in the exit face of the dispensing nozzle. The transverse slot is formed or bounded by first and second spray-limiting walls, the walls having interior facing surfaces set apart from each other at the exit face of the dispensing nozzle. The transverse slot further has a curved vertex end and an exit face end, wherein the curved vertex end is in fluid connection with the exit orifice, and the exit face end is in fluid connection with the exit face of the dispensing nozzle.

Between the exit face end and the curved vertex end of the transverse slot, the interior facing surface of the first spray-limiting wall has curvature towards the interior facing surface of the second spray-limiting wall, and the interior facing surface of the second spray-limiting wall has curvature towards the interior facing surface of the first spray-limiting wall, the two curved interior facing surfaces joining to form the curved vertex end to the traverse slot at the exit orifice, with the curved vertex end having a vertex.

Additionally, the exit orifice has a dimension L parallel to the transverse slot at the connection to the fan spray tip, as shown as “L” in FIG. 9 and the dimension 29 in FIGS. 5 & 7. The facing surfaces of the first and second spray-limiting walls are set apart a dimension W, as shown as “W” in FIG. 11. In some preferred embodiments, W is less than or equal to dimension L. The dimension W between the two walls is measured at the exit face of the spray fan tip of the dispersing nozzle; that is, in the plane orthogonal to the centerline axis of the dispensing nozzle at the exit face. In FIGS. 9, 10, & 12, W is necessarily less than dimension L because the taper of the tapered hollow annular channel extends through the spray fan tip to the exit face of the spray fan tip (and of the dispersing nozzle). In some embodiments, W could be the same as L if the hollow annular channel was not tapered, or if that taper did not extend into the spray fan tip.

The transverse slot has an overall depth D, as shown as “D” in FIG. 11, that is measured from the plane of the exit face of the dispensing nozzle to the vertex of the transverse slot.

Preferably, the ratio of D:W is 0.30 to 2.40. It has been found that if the D:W ratio is less than 0.30, the band of foam that is sprayed is too narrow, and if the D:W ratio is greater than 2.40 the band of foam that is sprayed is too wide. In some preferred embodiments, the ratio of D:W is 0.40 to 1.90.

In some embodiments, the dispensing nozzle is in fluid connection with a pressurized source of foamable material; and in some embodiments the pressurized source is an aerosol can or propellant container. It is conceivable that the dispensing nozzle comprises only the fan spray tip and this is directly connected to the outlet valve of an aerosol can or propellant container.

In some more preferred embodiments, however, the dispensing nozzle comprises a hollow annular channel, an exit orifice, and a fan spray tip, wherein the exit orifice for discharging the pressurized material to the fan spray tip is in fluid communication with an exit end of the hollow annular channel through the dispensing nozzle for the passage of the pressurized material through the dispensing nozzle, the hollow annular channel having an entrance end for fluid connection to the pressurized source of foamable material. In some embodiments, the cross-sectional dimension of hollow annular channel; that is, the diameter of the open annular space in the channel if it is circular, tapers from a maximum value at the entrance end of the hollow annular channel to a minimum value at the exit end of the hollow annular channel.

The transverse slot has a curved vertex end and an exit face end, wherein the curved vertex end is in fluid connection with the exit orifice, and the exit face end is in fluid connection with the exit face of the dispensing nozzle. In some embodiments, the curved vertex end to the traverse slot has the shape of or forms a half circle. In other words, the two facing surfaces of the spray-limiting walls curve towards one another to form a curved vertex end of the traverse slot that traces a half circle. In some embodiments, the curved vertex end to the traverse slot has the shape of or forms a semi-ellipse. In other words, the two facing surfaces of the spray-limiting walls curve towards one another to form a curved vertex end of the traverse slot that traces a half of an ellipse, also known as a semi-ellipse. In some embodiments, the curved vertex end to the traverse slot has the shape of or forms a parabola. In other words, the two facing surfaces of the spray-limiting walls curve towards one another to form a curved vertex end of the traverse slot that traces a parabola. While a half circle, a semi-ellipse, and a parabola are curved shapes, it is believed that the two facing surfaces could potentially meet to form the curved vertex end to the traverse slot in any curved interior surface that does not end at a point.

The process for spraying a band of foam of a desired width on a surface preferably dispenses foam through the dispensing nozzle at a flow rate of 20 grams per second or greater. In some embodiments the process for spraying a band of foam of a desired width on a surface is preferably dispenses foam through the dispensing nozzle at a flow rate of 20 to 60 grams per second, or of 20 to 40 grams per second. In some embodiments the process for spraying a band of foam of a desired width on a surface preferably dispenses foam through the dispensing nozzle at a flow rate that is 60 grams per second or less.

In many embodiments, the preferred foamable material is polyurethane foam. The process for spraying a band of foam can preferably use, and fan spray tip can be used to preferably spray, what is known the art as a 1-component spray foam formulation; however, it is understood the process and fan spray tip could be used with what is known in the art as a 2-component spray foam formulation (after mixing), or any other formulation or composition useful in making bands or layers of foam.

It is thought in some embodiments a desired or preferred width of a foam band sprayed on a surface (dimension 14 as shown in FIG. 1) using the inventive dispensing nozzle is from 4 to 18 inches, and with that inventive dispensing nozzle the amount of overspray is significantly reduced, with the sum of the widths of both overspray bands (dimensions 15 as shown in FIG. 1) in total being preferably 60 percent or less than the desired or preferred foam band width (dimension 14). This is in contrast with a V-shaped dispensing nozzle of the prior art, which has been shown to have significant overspray, with the sum of the widths of both overspray bands, for a similar foam band, being greater than 60 percent of the desired or preferred foam band width.

If desired, foam bands having the desired width of from 4 to 18 inches using the inventive process and/or dispensing nozzle can be made using a preferred foam dispense rate of about 20 to 60 grams per second through the dispensing nozzle, with the dispensing nozzle being preferably oriented about 8 to 20 inches from the surface, and the dispensing nozzle being preferably perpendicular to that surface (that is, not skewed so that both overspray bands have an equivalent width).

### EXAMPLES

Bands of foam were sprayed from an inventive dispensing nozzle having a fan spray tip having a transverse slot that has a curved interior surface that does not end at a point, such as shown in FIG. 3; the dispensing nozzle having a hollow annular channel with a single straight taper throughout. As a comparison, a V-shaped fan spray tip of the prior art, such as shown in FIG. 2 as used. The inventive transverse slot had a width or “W” dimension of 2.64 mm and depth or “D” dimension of 3.22 mm for a D: W ratio of 1.22; and the curved vertex end of the traverse slot had the shape of a half circle. The comparison V-shaped fan spray tip had a width or “W” dimension of 1.32 mm and depth or “D” dimension of 3.22 mm for a D: W ratio of 2.44.

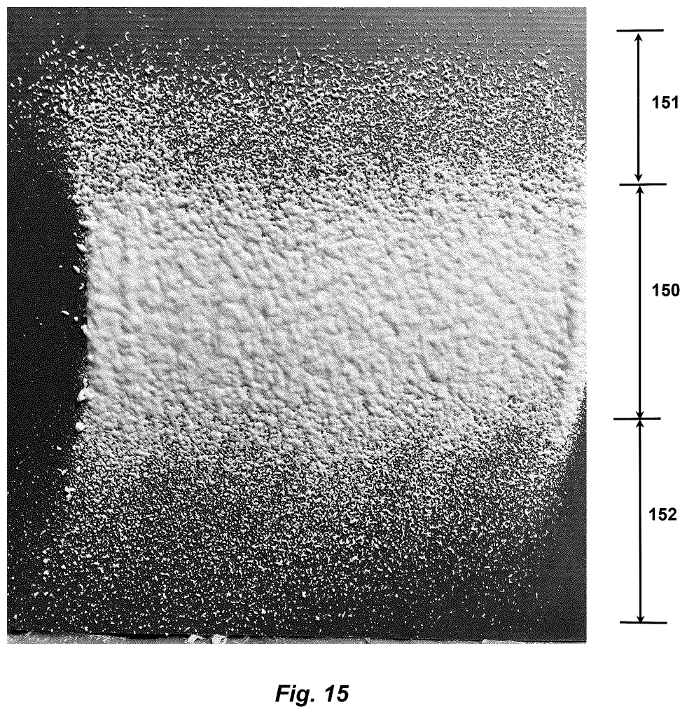

Fans of foams were sprayed from a pressurized source onto cardboard surfaces to form a band of foam. As shown in the digital photo of FIG. 15 using the comparison V-shaped spray fan tip, the desired foam band 150 was nominally about 12 inches in width; but had an overspray band 151 of about 7.5 inches on one side and an overspray band 152 of about 11 inches on the other side. The overspray bands were not symmetrical due to the real-world application of the foam at a slight angle from horizontal. The additive sum of the overspray, of 11+7.5=18.5 inches, represented an overspray of greater than 150% of the desired 12 inch band, and the bits of foam distributed over an area having an overall width of about 30.5 inches.

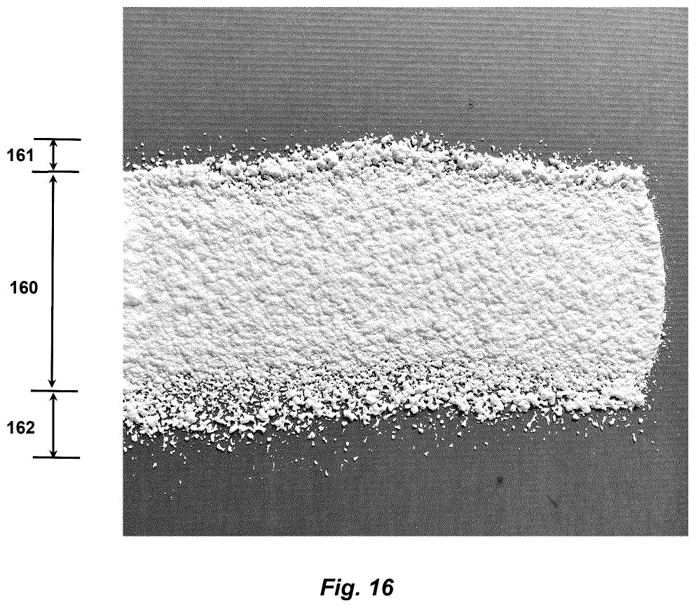

As shown in the digital photo of FIG. 16 using the inventive spray fan tip and the same pressurized source, the desired foam band 160 was nominally about 11 inches in width and had an overspray band 161 (liberally measured) of only about 2 inches on one side and an overspray band 162 of only about 4 inches on the other side. Again, the overspray bands were not symmetrical due to the real-world application of the foam at a slight angle from horizontal. The additive sum of the overspray, of 2+4=6 inches, represented an overspray of only 55% of the desired 11 inch band, and the bits of foam was distributed over an area having an overall width of only about 17 inches.

1. A process for spraying a band of foam of a desired width on a surface, comprising
a) providing a pressurized source of foamable material having a dispensing nozzle for spraying a fan spray, or attaching a dispensing nozzle for spraying a fan spray to a pressurized source of foamable material,
wherein said pressurized source is in fluid connection with the dispensing nozzle, the dispensing nozzle comprising an exit orifice for discharging the pressurized material, the exit orifice in fluid connection with a fan spray tip for forming the fan spray, the fan spray tip forming an exit face of the dispensing nozzle,
wherein the fan spray tip provides a transverse slot in the exit face of the dispensing nozzle,
the transverse slot formed by first and second spray-limiting walls, the walls having facing surfaces set apart from each other at the exit face of the dispensing nozzle,
the transverse slot having a curved vertex end and an exit face end,
wherein the curved vertex end is in fluid connection with the exit orifice, and the exit face end is in fluid connection with the exit face of the dispensing nozzle,
wherein the first spray-limiting wall has an interior surface facing the second spray-limiting wall, and the second spray-limiting wall has an interior surface facing the first spray-limiting wall, and
wherein between the exit face end and the curved vertex end of the transverse slot, the interior surface of the first spray-limiting wall has curvature towards the interior surface of the second spray-limiting wall, and the interior surface of the second spray-limiting wall has curvature towards the interior surface of the first spray-limiting wall, the two interior surfaces joining to form the curved vertex end of the traverse slot at the exit orifice, the curved vertex end having a vertex, and
wherein
i) the exit orifice has a dimension L parallel to the transverse slot at the connection to the fan spray tip,
ii) the facing surfaces of the first and second spray-limiting walls are set apart a dimension W at the exit face of the dispensing nozzle,
iii) the transverse slot has an overall depth D measured from the exit face of the dispensing nozzle to the vertex of the transverse slot, and
iv) the ratio of D:W is 0.30 to 2.40;
b) dispensing onto a surface a fan spray of the foamable material from the dispensing nozzle,
the fan spray having a centerline plane that is parallel with the slot in the dispensing nozzle, and
c) moving the dispensing nozzle perpendicular to the centerline plane of the fan spray to form a band of foam of the desired width on the surface.

2. The process of claim 1, wherein the exit orifice for discharging the pressurized material to the fan spray tip is in fluid communication with an exit end of a hollow annular channel through the dispensing nozzle for the passage of the pressurized material through the dispensing nozzle, the hollow annular channel having an entrance end for fluid connection to the pressurized source of foamable material.

3. The process of claim 2, wherein the hollow annular channel has a cross-sectional dimension, and the cross-sectional dimension tapers from a maximum value at the entrance end of the hollow annular channel to a minimum value at the exit end of the hollow annular channel.

4. The process of claim 1, wherein the curved vertex end to the traverse slot has the shape of a half circle.

5. The process of claim 1, wherein the curved vertex end to the traverse slot has the shape of a semi-ellipse.

6. The process of claim 1, wherein the curved vertex end to the traverse slot has the shape of a parabola.

7. The process of claim 1, wherein the ratio of D:W is 0.40 to 1.90.

8. The process of claim 1, wherein the pressurized source is an aerosol can or propellant container.

9. The process of claim 1, wherein the foam is dispensed at a flow rate of 20 grams per second or greater.

10. The process of claim 1, wherein the foamable material is polyurethane foam.

11. A dispensing nozzle for spraying a fan spray of a foamable material, the dispensing nozzle comprising an exit orifice and a fan spray tip, the exit orifice for discharging the foamable material and the fan spray tip for forming the fan spray, the fan spray tip forming an exit face of the dispensing nozzle,
wherein the fan spray tip provides a transverse slot in the exit face of the dispensing nozzle,
the transverse slot formed by first and second spray-limiting walls, the walls having facing surfaces set apart from each other at the exit face of the dispensing nozzle,
the transverse slot having a curved vertex end and an exit face end,
wherein the curved vertex end is in fluid connection with the exit orifice, and the exit face end is in fluid connection with the exit face of the dispensing nozzle,
wherein the first spray-limiting wall has an interior surface facing the second spray-limiting wall, and the second spray-limiting wall has an interior surface facing the first spray-limiting wall, and
wherein between the exit face end and the curved vertex end of the transverse slot, the interior surface of the first spray-limiting wall has curvature towards the interior surface of the second spray-limiting wall, and the interior surface of the second spray-limiting wall has curvature towards the interior surface of the first spray-limiting wall, the two interior surfaces joining to form the curved vertex end to the traverse slot at the exit orifice, the curved vertex end having a vertex, and
wherein
i) the exit orifice has a dimension L parallel to the transverse slot at the connection to the fan spray tip,
ii) the facing surfaces of the first and second spray-limiting walls are set apart a dimension of W at the exit face of the dispensing nozzle,
iii) the transverse slot has an overall depth D from the exit face of the dispensing nozzle to the vertex of the transverse slot, and
iv) the ratio of D:W is 0.30 to 2.40.

12. The dispensing nozzle of claim 11, wherein the exit orifice for discharging the pressurized material to the fan spray tip is in fluid communication with an exit end of a hollow annular channel through the dispensing nozzle for the passage of the pressurized material through the dispensing nozzle, the hollow annular channel having an entrance end for fluid connection to the pressurized source of foamable material.

13. The dispensing nozzle of claim 12, wherein the hollow annular channel has a cross-sectional dimension, and the cross-sectional dimension tapers from a maximum value at the entrance end of the hollow annular channel to a minimum value at the exit end of the hollow annular channel.

14. The dispensing nozzle of claim 11, wherein the curved vertex end to the traverse slot has the shape of a half circle.

15. The dispensing nozzle of claim 11, wherein the curved vertex end to the traverse slot has the shape of a semi-ellipse.

16. The dispensing nozzle of claim 11, wherein the curved vertex end to the traverse slot has the shape of a parabola.

17. The dispensing nozzle of claim 11, wherein the ratio of D:W is 0.40 to 1.90

18. The dispensing nozzle of claim 11, wherein the dispensing nozzle is in fluid connection with a pressurized source of foamable material.

19. The dispensing nozzle of claim 18, wherein the pressurized source is an aerosol can or other propellant container.

20. The dispensing nozzle of claim 11, wherein the foamable material is polyurethane foam.
